(19) United States
(12) Patent Application Publication
(10) Pub. No.: US 2025/0303303 A1
(43) Pub. Date: Oct. 2, 2025

(54) PLAYABLE CONTENT

(71) Applicant: Sony Interactive Entertainment Inc., Tokyo (JP)

(72) Inventor: Anthony Graziano, San Mateo, CA (US)

(21) Appl. No.: 18/623,915

(22) Filed: Apr. 1, 2024

(51) Int. Cl. A63F 13/77; A63F 13/35

(52) U.S. Cl. CPC A63F 13/77; A63F 13/35; A63F 2300/40; A63F 2300/57

(57) ABSTRACT

A computer game from an influencer can be viewed on a mobile device and a user given the opportunity to play the game on the mobile. Game progress can be viewed on the mobile device and once the user is home, game play can be switched to a smart TV.

### FIELD

The present application relates generally to playable content.

### BACKGROUND

A computer gamer who may only dabble in game play typically uses mobile devices to play games as they travel through the day.

### SUMMARY

Present principles understand that such “dabblers” may wish to transfer game play from their mobile device to other screens when, for instance, they arrive home.

Accordingly, a method includes sending a saved computer game from a computer game console to a server. The method further includes reconfiguring at least one clip of the computer game for presentation on a mobile computing device. Also, the method includes sending the clip of the computer game after reconfiguring it to at least one mobile computing device to enable the mobile computing device to present the clip computer game in a view-only mode to share the game, and responsive to input at the mobile computing device, change mode of the computer game to allow playing the computer game using the mobile computing device.

In some examples the method can include sending only the clip and no other portion of the compute game to the mobile computing device to enable sharing.

In examples, the mobile computing device is a first device and the method may include sending the clip from the first device to a second computing device that may be a mobile device or a computer game console.

In example implementations the method may include presenting on the mobile computing device, with the clip in view-only mode, an offer to purchase the computer game, and/or an offer to join a computer game network, and/or an offer to stream the computer game to the mobile computing device, and/or an offer to stream the computer game to a device other than the mobile computing device.

In an example embodiment, the method can includes establishing a start point and/or end point of the clip based at least in part on input from the mobile computing device.

In other examples the method may include sending the clip to the mobile computing device over a social network.

In a non-limiting implementation the method includes inputting the clip to at least one machine learning (ML) model, receiving from the ML model a narrative related to the clip, and presenting the narrative with the clip on the mobile computing device.

In another aspect, a processor system is configured to present a video game on a mobile device in view-only mode, and switch to enabling play of the video game on the mobile device.

The system also is configured to enable sharing the video game from the mobile device to another computer, and to enable purchase rights related to the video game.

In another aspect, a device includes at least one computer memory that is not a transitory signal and that in turn includes instructions executable by at least one processor system to share a clip of an influencer-generated recording of a video game with a mobile device using a social network. The instructions also are executable to enable the mobile device to share the clip with other computing devices, and enable play of the clip on the mobile device.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example system architecture;

FIG. 3 illustrates example logic in example flow chart format;

FIG. 4 illustrates example logic in example flow chart format for training a machine learning (ML) model to provide a narrative for a game clip;

FIG. 5 illustrates example logic in example flow chart format for using the ML model to provide clip narrative;

FIG. 6 illustrates an example screen shot consistent with FIG. 5;

FIG. 7 illustrates an example screen shot for defining clip start and end times;

FIG. 8 illustrates an example screen shot for an influencer to upload a game to the loud for sharing;

FIGS. 9-13 illustrate example screen shots for introducing a dabbler to a video game using a clip from the game;

FIG. 14 illustrates an example screen shot for switching from view-only to play mode;

FIG. 15 illustrates an example screen shot consistent with FIG. 14;

FIG. 16 illustrates an example screen shot for showing a player progress in playing the clip;

FIG. 17 illustrates an example screen shot for continuing play; and

FIG. 18 illustrates an example screen shot for presenting the user options for paying for continued play.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

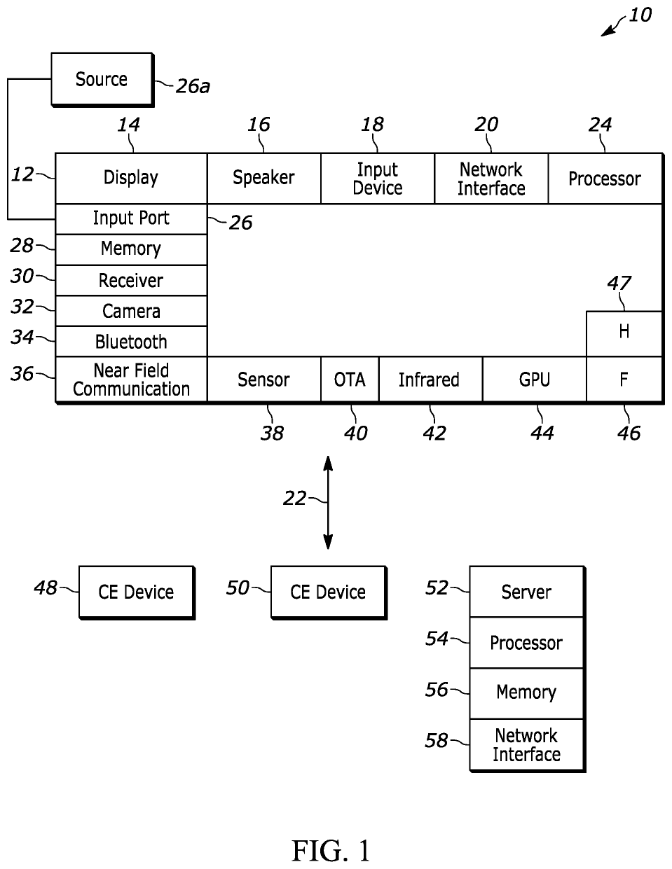

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

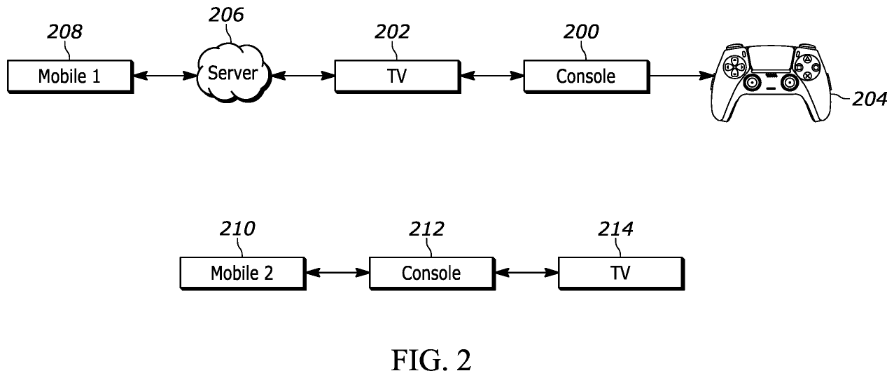

Refer now to FIG. 2. A computer simulation console 200 such as a computer game console presents a computer or video game on a display 202 such as a TC under control of a computer simulation controller 204. The game may have been played by an influencer, for example, and can be stored in a cloud server system 206 for access by a mobile device 208 to present at least a clip of the game. The mobile device 210 may share the clip with another mobile device 210 and may share the clip and/or the game with another computer simulation console 212 such as a console owned by the owner of the mobile device 208 for display of the game on a display 214 such as a TV.

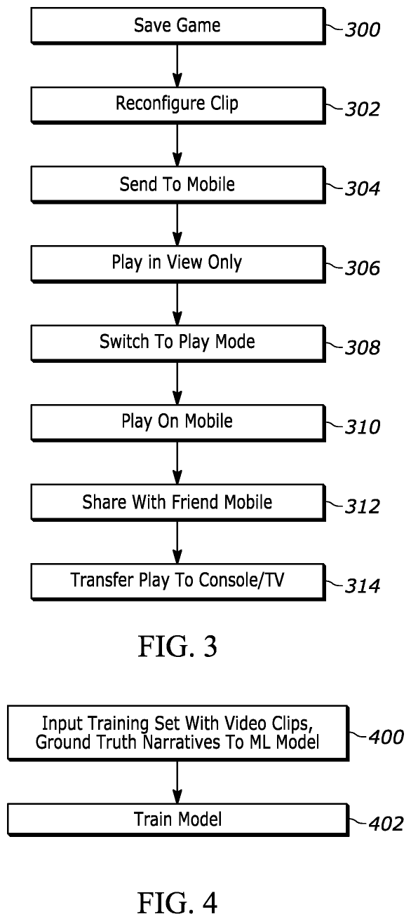

FIG. 3 illustrates example logic consistent with present principles. Commencing at state 300, a saved computer game may be sent from a computer game console to a server. Moving to state 302, at least a clip of the game video and if desired the entire game video may be reconfigured for presentation on a mobile computing device by, e.g., lowering the video resolution and changing its aspect ratio.

The game or at least a clip (and in some embodiments only a clip) of the game video are sent at state 304 to a mobile computing device such as a mobile phone. The mobile device may play the clip in a view-only mode at state 306 in which the clip plays but cannot be controlled by the mobile device.

Proceeding to state 308, responsive to input at the mobile computing device, the mode of the computer game may be changed to allow playing the computer game using the mobile computing device. State 310 indicates that the game may be played by allowing a user of the mobile device to input control signals to the game.

State 312 indicates that the game clip may be shared with another mobile device (or with a computer game console) by, e.g., sending a link to the clip to the device being shared with. Sharing may be permitted only in the view-only mode, or only in the play mode, or in both the view-only and play modes. The game publisher or game service provider may define how much sharing can be done with other players.

At state 314, play of the game may shift to a computer game console when, for example, the user of the mobile device returns home and links the game, e.g., via Bluetooth or Wi-Fi, to the console with a timestamp indicating where in the game the user had paused it or had arrived at. Control of the game presented by the console on a TV may remain with the mobile device controls if desired or shifted to a computer game controller. The user may be presented selectors to decide which.

Further techniques may be appreciated in reference to FIGS. 4-6. Commencing at state 400, a training set of data that may include multiple video clips and accompanying text narratives is input to state 402 to train a machine learning (ML) model to generate text-based narratives to video clips.

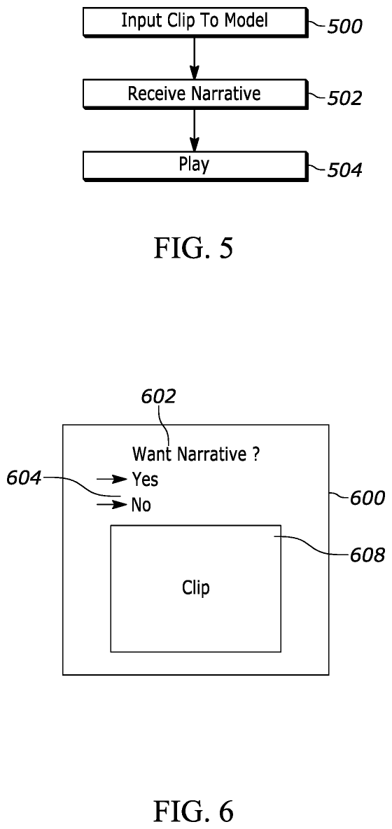

Accordingly, during presentation of the game clip on, e.g., a mobile device, at state 500 of FIG. 5 the clip can be input to the ML model, which generates a text-based narrative that is received by the mobile device at state 502 and presented along with the clip either in text or voice-from-text form at state 504. As illustrated in FIG. 6, a display 600 such as a display of any device herein including a mobile device may present a prompt 602 inquiring whether a narrative is desired along with selectors 604 to select whether to to play the narrative along with the clip 606.

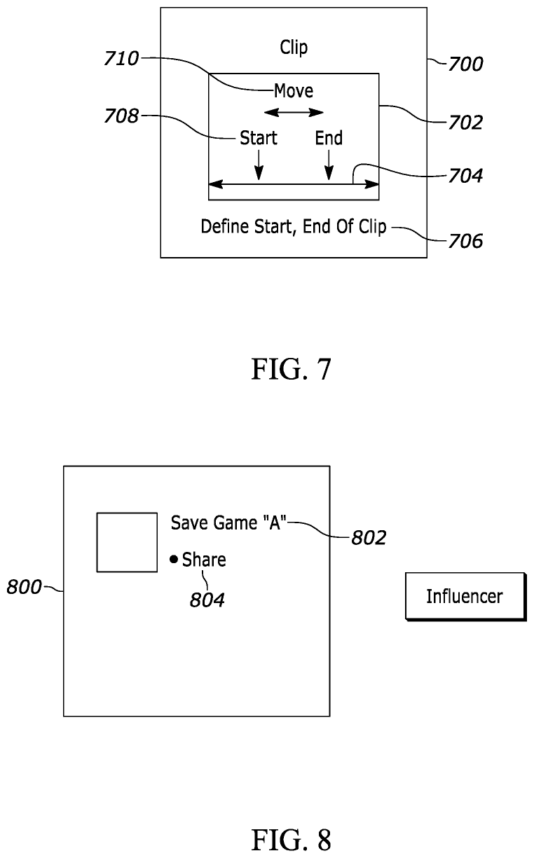

FIG. 7 illustrates a display 700 such as a display of any device herein in which a game clip may be presented in a window 7802 of the display 700. A timeline 704 of the entire game or portion thereof may be presented along with a prompt 706 to define a desired start and end time for a final clip by moving start and end selectors 708 side to side as indicated by the move indicator 710. Other techniques for defining clip start and end time by the end user may be used. FIG. 8 illustrates a display 800 such as a display of any device herein, in the example shown, an influencer device, to save game “A” as indicated at 802 and to select whether to share the game by up-loading it to a cloud server such as a social media server using a selector 806.

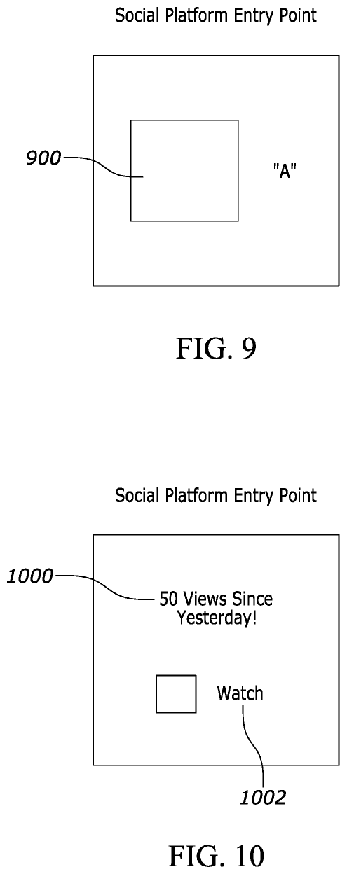

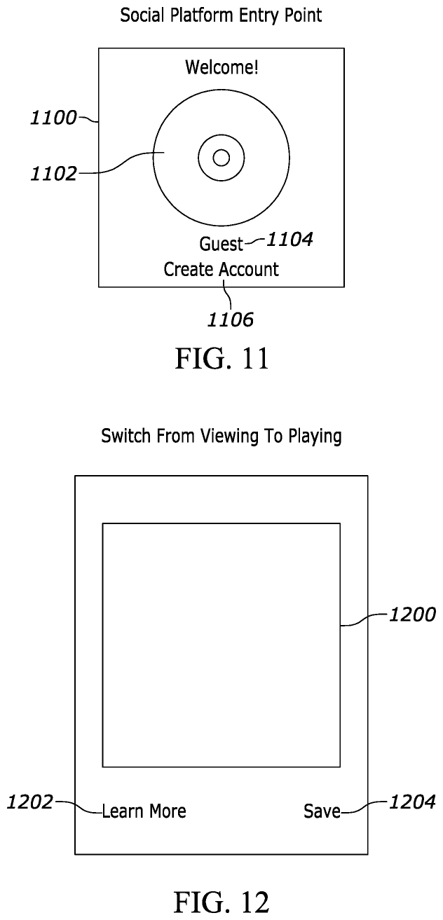

FIG. 9 illustrates a screen shot of an end user display such as the display of a mobile device of a “dabbler”, i.e., a person who may not be intimately familiar with gaming but who may be interested to view clips and perhaps engage in rudimentary game play as an introduction to the field. A game icon 900 for game “A” shared by the influencer may be presented. If the icon is selected, the screen shot of FIG. 10 may be presented indicating at 1000 a number of recent views of the game (or clip as the case may be) and presenting a selector 1002 to watch the clip. Selection of the watch icon may invoke the screen shot of FIG. 11 showing a welcome message and a selector 1102 to begin watching the clip a guest 1104 or enroll in an account as indicated at 1106.

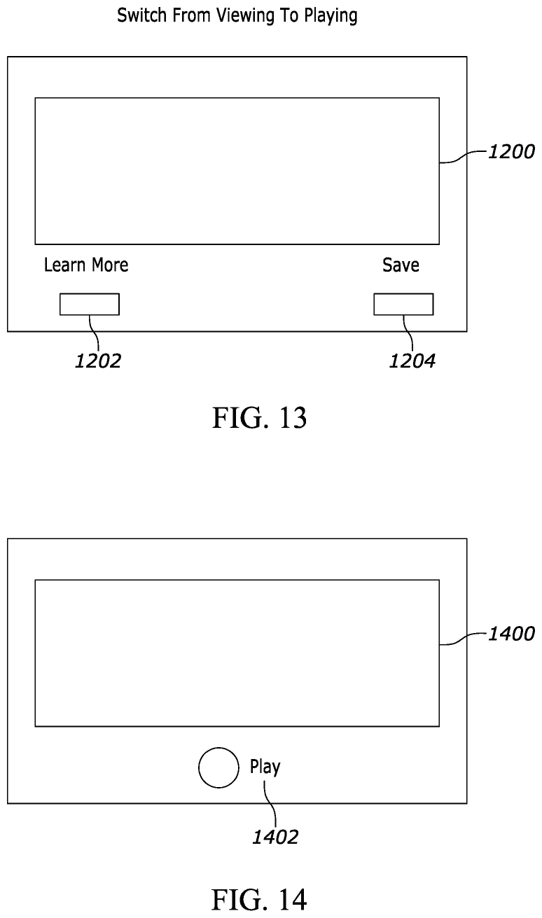

FIGS. 12 and 13 illustrate portrait and landscape modes, respectively, of the mobile device showing the game being presented in a window 1200. A “learn more” selector 1202 may be presented which, if selected, brings up information on the device about the game, how to play it, and how to buy it. A save selector 1204 may be provided to allow the dabbler to save the current clip at a current location in the game.

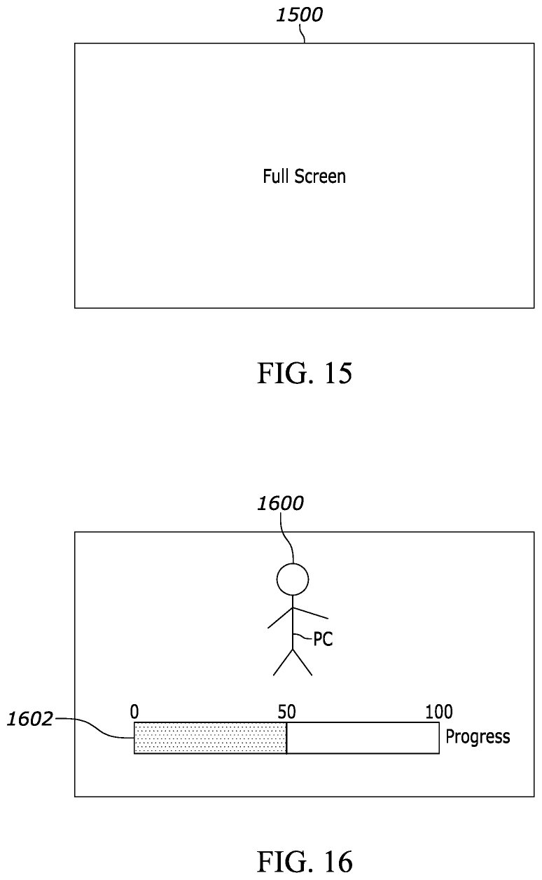

FIG. 14 illustrates a screen shot of the mobile device presenting the video game clip in a window 1400 of the device along with a selector 1402 to switch from view-only mode as in FIGS. 9-13 to play mode, in which the dabbler can input game control signals to control presentation of the game using voice input or keypad input. FIG. 15 illustrates that responsive to switching from view-only to play mode, the clip may be presented full screen 1500.

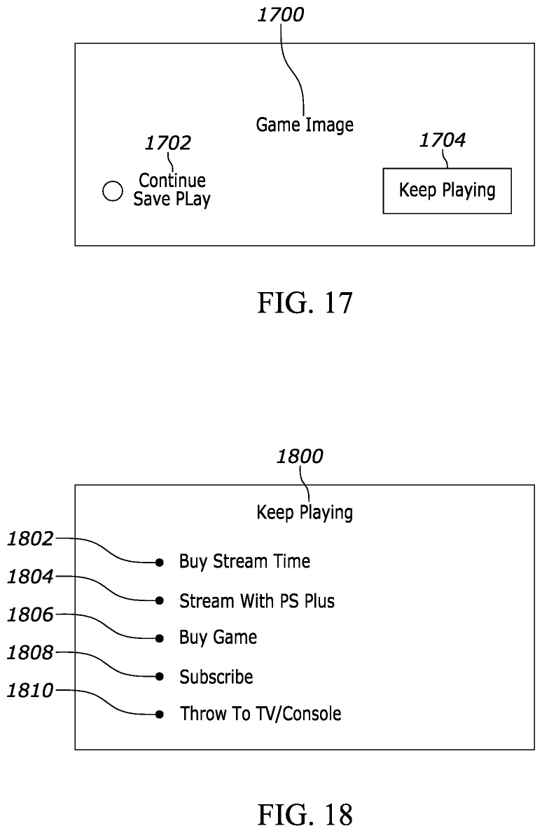

During play of the clip, the screen shot shown in FIG. 16 may be presented on the mobile device, showing a player character 1600 in the game and a timeline indicator 1602 indicating the amount of the game that has been played so far. FIG. 17 illustrates yet another screen shot illustrating a game still or video image 1700 and a selector 1702 selectable to save past play on the mobile device and/or continue playing by selecting a selector 1704.

FIG. 18 illustrates a screen shot that may be presented after X minutes of play, or after the short clip has run, or at other defined time to prompt the user at 1800 that to keep playing, the user may purchase more screen time by selecting selector 1802, stream the game using a game streaming service by selecting a selector 1804, or purchase the entire game by selecting a selector 1806. Also, a selector 1808 may be provided to select to subscribe to a gaming service. A selector 1810 may be selected to throw the game to a nearby game console in, e.g., Bluetooth communication with the mobile device.

While the particular embodiments are herein shown and described in detail, it is to be understood that the subject matter which is encompassed by the present invention is limited only by the claims.

What is claimed is:

1. A method comprising:
sending a saved computer game from a computer game console to a server;
reconfiguring at least one clip of the computer game for presentation on a mobile computing device;
sending the clip of the computer game after reconfiguring it to at least one mobile computing device to enable the mobile computing device to present the clip computer game in a view-only mode to share the game; and
responsive to input at the mobile computing device, change mode of the computer game to allow playing the computer game using the mobile computing device.

2. The method of claim 1, comprising:
sending only the clip and no other portion of the compute game to the mobile computing device to enable sharing.

3. The method of claim 1, wherein the mobile computing device is a first device and the method comprises:
sending the clip from the first device to a second computing device.

4. The method of claim 3, wherein the second computing device is a mobile device.

5. The method of claim 3, wherein the second computing device is a computer game console.

6. The method of claim 1, comprising presenting on the mobile computing device, with the clip in view-only mode, an offer to purchase the computer game.

7. The method of claim 1, comprising presenting on the mobile computing device, with the clip in view-only mode, an offer to join a computer game network.

8. The method of claim 1, comprising presenting on the mobile computing device, with the clip in view-only mode, an offer to stream the computer game to the mobile computing device.

9. The method of claim 1, comprising presenting on the mobile computing device, with the clip in view-only mode, an offer to stream the computer game to a device other than the mobile computing device.

10. The method of claim 1, comprising establishing a start point and/or end point of the clip based at least in part on input from the mobile computing device.

11. The method of claim 1, comprising sending the clip to the mobile computing device over a social network.

12. The method of claim 1, comprising:
inputting the clip to at least one machine learning (ML) model;
receiving from the ML model a narrative related to the clip; and
presenting the narrative with the clip on the mobile computing device.

13. A processor system configured to:
present a video game on a mobile device in view-only mode;
switch to enabling play of the video game on the mobile device;
enable sharing the video game from the mobile device to another computer; and
enable purchase rights related to the video game.

14. The processor system of claim 13, wherein the processor system is configured to:
present only a clip of the video game on the mobile and no more of the video game unless input is received accepting purchase rights.

15. The processor system of claim 13, wherein purchase rights comprise purchasing the computer game.

16. The processor system of claim 13, wherein purchase rights comprise joining a computer game network.

17. The processor system of claim 13, wherein purchase rights comprise streaming the computer game to the mobile computing device.

18. The processor system of claim 13, wherein the processor system is configured to:
input a clip of the video game to at least one machine learning (ML) model;
receive from the ML model a narrative related to the clip; and
present the narrative with the clip on the mobile computing device.

19. A device comprising:
at least one computer memory that is not a transitory signal and that includes instructions executable by at least one processor system to:
share a clip of an influencer-generated recording of a video game with a mobile device using a social network;
enable the mobile device to share the clip with other computing devices; and
enable play of the clip on the mobile device.

20. The device of claim 19, comprising the at least one processor system.
